(19) United States
(12) Patent Application Publication
(10) Pub. No.: US 2016/0196702 A1
(43) Pub. Date: Jul. 7, 2016

(54) PARKING SYSTEM AND METHOD OF CUSTOMER TRACKING IN A PARKING FACILITY

(71) Applicant: Clyde Bartlett WILSON, Austin, TX (US)

(72) Inventor: Clyde Bartlett WILSON, Austin, TX (US)

(21) Appl. No.: 15/016,565

(22) Filed: Feb. 5, 2016

Related U.S. Application Data
(63) Continuation-in-part of application No. 14/061,604, filed on Dec. 20, 2013, now abandoned.

(51) Int. Cl. G07C 9/00; G06Q 30/02; G06K 9/00

(52) U.S. Cl. CPC G07C 9/00134; G06K 9/00785; G06K 9/00771; G06Q 30/0284; G06K 2209/15; G06Q 2240/00

(57) ABSTRACT

A parking system and method of tracking parking vehicles at a parking facility includes providing a first control panel and a camera adjacent an entrance of the parking facility, entering a customer number into the first control panel, recognizing characters on a license plate by the camera at the entrance, allowing the vehicle to enter the parking facility, entering the customer number upon an exit from the parking facility, and allowing exit from the parking facility if the customer number matches the customer number entered at the entrance. The exit is allowed from the parking facility if the customer number and the characters of the license plate at the entrance match the characters of the license plate and the customer number at the exit.

### CROSS-REFERENCE TO RELATED APPLICATIONS

The present application is a continuation-in-part of U.S. patent application Ser. No. 14/061,604, filed in Dec. 20, 2013, and entitled “Alternative Customer Tracking for Parking Facilities”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to parking systems and relates to the control of ingress and egress of vehicles from a parking facility. More particularly, the present invention relates to apparatus and methods for tracking the amount of time that a vehicle resides at the parking facility. More particularly, the present invention relates to control panels and cameras as used in connection with the detection of vehicles entering and exiting the parking facility.

2. Description of Related Art Including Information Disclosed Under 37 CFR 1.97 and 37 CFR 1.98

Generally, parking facilities charge for the amount of time that a customer is parked in a facility. In order to determine this time, over the years, parking facilities have used a parking ticket that has the time, date, facility code and lane number printed on the face of the ticket. Typically, the parking ticket is made of paper and issued from a machine that encodes the ticket with the identifying information described above. The information is coded on the paper ticket by printing the information on the face of the ticket and/or by placing the information on the magnetic strip or on a barcode of the ticket. The parking ticket is issued to the customer usually at the entrance of the parking facility and, at the time of entry, the time of the customer's stay in the facility begins. In order to pay for parking, the customer must present the ticket received from the entry machine at an exit station. The exit station can be a pay-on-foot station that a person walks up to. This pay-on-foot station will accept the ticket in order to compute the fee. It will then accept the customer's payment in the form of a credit card, cash, validation, etc. The exit station can also be a similar device in the exit lane. The exit station can also include a human cashier.

The parking customer must present the ticket received at the entrance to the machine or human cashier in order to allow the facility to compute the parking fee due. At a pay-on-foot station or at the exit lane station, the customer must insert the ticket into the machine. The machine has a tractor-feed that moves the ticket into and over the read heads in order to read the magnetic strip or the barcode. If the reader is dirty because of paper dust, if the software develops issues on the entrance machine, if the customer has damaged the ticket so that the barcode or magnetic code cannot be read, or if the customer has come into contact with a magnetic field, the ticket information may not be readable. In this era of automation, most customers will pay for the parking at a pay-on-foot station, a machine that customers walk up to in order to pay, which is not located at the exit of the facility. The pay-on-foot stations are also remote from the customers' cars. As such, customers must remember to take their entry tickets with them after parking and when they exit their cars. If the customers do not take their ticket with them, they will not have the ticket with the entry information required to compute their fee in order to make payment.

After the customer pays at the pay-on-foot station, the ticket has new payment information encoded on it. The customer must then stop at the exit gate and present the ticket to the in-lane exit machine or to the human cashier. This process is to determine that the customer has paid for his or her parking before he or she is let out of the facility. It also confirms that since the payment at the pay-on-foot station, the customer has not exceeded the amount of time allowed from the time of payment to when he or she must arrive at the exit in order to not incur additional time charges. This is often referred to as the “grace period”. If the customer does not reach the exit in the predetermined grace period amount of time (e.g. 15 minutes), the customer will have to pay an additional fee for the access time.

This entire process is very bulky, requires many steps, and is prone to errors. The process requires the operator of the parking facility to regularly stock the ticket-issuing machines at the entrance with tickets, order, track, securely store the tickets, and make sure that all of the moving parts in the ticket dispenser are not scratching the tickets as they move inside the machine. On the customer side, the current process requires the customer to take the ticket from the machine and find temporary storage before proceeding through the entrance. It requires the customer to remember to take their ticket with them as they exit the vehicle and to carry around this piece of paper with them that contains the entry time information. The ticket is made of paper that can bend, tear, get wet, get lost, or become demagnetized. As such, a need has developed so as to provide a system which corrects this wide variety of inefficiencies in these prior art processes.

Contract partners are billed on a regular basis. As such, they do not pull tickets to enter the garage and make payments each time they leave. Contract partners use an encoded card, badge, or an automatic vehicle identification access device that has a specific number to differentiate the individual contract parker. These cards can be left at home, malfunction, the reader can malfunction, the cards can be turned off accidentally, be left in another vehicle, or the automatic vehicle identification access device is attached only to one vehicle while the contract parker drives another vehicle. All of these issues cause access to the parking facility to become difficult. As such, the contract parker would need to obtain assistance in order to enter or exit the facility.

As such, a need has developed so as to provide a system whereby contract parkers will be recognized by their license plate, automatic vehicle identification codes, or contract car codes, along with their phone number or other identifying code.

In the past, various patents have issued relating to the control of ingress and egress of vehicles from parking facilities. For example, U.S. Pat. No. 5,414,624, issued on May 9, 1995 to R. B. Anthonyson, describes an automated vehicle parking system for a parking facility. This automated vehicle parking system communicates with the vehicle approaching or leaving the facility with radio frequency signals, or the like, and identify the vehicle and send the vehicle identification number, time of day, and lane number to a central computer so as to calculate the parking cost based on rates for each individual vehicle stored in the computer.

U.S. Pat. No. 6,085,124, issued on Jul. 4, 2000 to D. J. Choi, teaches an automated parking system in which the computer, the parking ticket issuer, and the parking ticket recognizer are connected in a network such that each unit exchanges information as it needs. The system controls processes of loading and unloading a car, issuing the parking ticket, recognizing the parking ticket, and calculating the fee for ensuring accuracy of the calculation. The parking system includes a keyboard, a mouse, and a database for storing vehicle data number. These are input from a keyboard. Loading information data, which is received in loading a car in each respective data field, is also provided. A display serves to display the information data. A data processor is connected to the parking installation controller for processing car loading/unloading information data. A loading/unloading control processor controls operation of the parking installation controller. A calculating processor serves to calculate and display a parking fee.

U.S. Pat. No. 6,519,329, issued on Feb. 11, 2003 to T. Hjelmbik, shows a vehicle parking system in which a mobile phone can be used to commence and terminate a parking period. A user sends at least one code to a receiving computer at the commencement and termination of a parking period via a mobile telephone system or a permanent telephone system. When a user first connects to the parking system by telephone in order to be able to park the user's vehicle within the system and to communicate parking commencement and termination times with the aid of a telephone, a pay meter, a cash card terminal, or some corresponding device is caused to mechanically read a cash card that is owned by the user and that is accepted by the parking system as a means for payment. The data read from the cash card is stored in a database in a parking system computer. At least one user-specific reference is entered and stored in the database and is associated with the cash card data for subsequent identification of the user and for billing the user for parking.

U.S. Pat. No. 6,823,317, issued on Nov. 23, 2004 to Ouimet et al., describes an urban parking system that includes a wireless network covering a large local geographical area in order to link a large number of payment terminals provided in the same area. Each payment terminal is located near a plurality of parking spaces, either at the curbside or municipal lots. Parking data is gathered from motorists at the payment terminals. The parking data includes vehicle identification data or parking space identification data. The parking data is sent from the payment terminals to the wireless network in response to payments made at the payment terminals.

U.S. Pat. No. 8,374,910, issued on Feb. 12, 2013 to K. Spasokukotskiy, teaches an automated system for the parking of vehicles. The system comprises a communications center module for interacting with a customer, a payment module for processing payments, a data storage module, and an analysis module for detecting potential parking violations and producing one or more enforcement alerts that are communicated to enforcement officers by a parking facility. The communications center module may recognize previous users of the system using at least one of customer identity data, customer biometric data, and customer behavioral data. Parking unit identity data and customer identity data may be conveyed by consumer contact with the parking facility.

It is an object of the present invention to provide a method and system that eases ingress and egress of vehicles from parking facilities.

It is another object of the present invention to provide a system and method that greatly improves the efficiency of parking facilities.

It is another object of the present invention to provide a system and method that avoids errors in tracking the amount of time that a user stays in a parking facility.

It is another object of that of the present invention to provide a system and method that avoids the need for access devices at the parking facility.

It is another object of the present invention to provide a system and method that avoids the need for the vehicle owner to carry any type of documentation.

It is a further object of the present invention to provide a system and method in which parking is carried out in a ticketless manner.

It is a further object of the present invention to provide a system and method for providing a record of vehicle transactions at the parking facility.

It is another object of the present invention to provide a system and method that monitors parking lot usage.

It is another object of the present invention to provide a system and method that assures payment and assures the accuracy of payment based upon the amount of time that the user uses the parking facility.

It is another object of the present invention to provide a system and method that improves revenue to the parking facility.

It is still another object of the present invention to provide a system and method that improves customer satisfaction relative to the use of the parking facility.

These and other objects and advantages of the present invention will become apparent from a reading of the attached specification and appended claims.

### BRIEF SUMMARY OF THE INVENTION

The present invention is a method of controlling ingress and egress of vehicles in a parking facility. This method includes the steps of: (1) providing a first control panel and a camera adjacent and entrance of the parking facility; (2) entering a customer number into the first control panel; (3) recognizing characters on a license plate by the camera at the entrance; (4) allowing the vehicle to enter the parking facility; (5) entering the customer number upon an exit from the parking facility; and (6) allowing exit from the parking facility if the customer number matches the customer number entered at the entrance.

In the method of the present invention, the characters of the license plate are correlated with the customer number. Exit is allowed from the parking facility if the customer number and the characters of the license plate at the entrance match the characters of the license plate and the customer number at the exit.

In the method of the present invention, a second control panel is provided associated with the exit of the parking facility. The customer number will be entered into the second control panel. Payment information can be entered in the second control panel. The exit is allowed from the parking facility upon the entry of payment information into the second control panel.

The method of the present invention further includes detecting a presence of the vehicle at the entrance of the parking facility. The customer number and the characters of the license plate can be transmitted to a remote location. The gate is lifted when the camera recognizes the characters of the license plate and when the customer number is entered at the entrance. The payment is calculated based upon an amount of time passing between the step of allowing the entrance of the vehicle and allowing exit of the vehicle. The payment is calculated based upon an amount of time passing between the step of allowing the entrance and when the customer number is entered upon exit. The customer number is an alphanumeric code of at least five digits.

The present invention is also a parking system that comprises an entrance gate, a first control panel positioned adjacent to the entrance gate, a first camera directed so as to recognize characters of the license plate of a vehicle positioned adjacent the entrance gate, an exit gate, a second control panel associated with the exit gate, and a processor connected the first control panel and the second control panel for allowing the exit gate to open if the customer number of the first control panel matches the customer number of the second control panel. The first control panel includes a first keypad thereon adapted to allow an entry of the customer number by customer. The second control panel includes a second keypad adapted to allow the entry of the customer number thereon.

The processor is connected the first control pad and to the first camera so as to correlate the customer number with the license plate. The processor is connected to the second control pad and to the second camera so as to recognize that the customer number and the characters of the license plate at the entrance gate match the customer number and the characters of the license plate at the exit gate. In an embodiment of the present invention, the entrance gate and the exit gate can be a common gate. It is important to realize that a single gate or a pair of gates can be used in association with the present invention.

The processor manages the equipment. The calculation of the amount of time passing between an opening of the entrance gate and the entry of the customer number is cloud-based. Additionally, the calculation of payment is carried out in the cloud. The amount to be paid is displayed on the display. The second control panel has a payment entry thereon. The second control panel also has a display thereon. A proximity sensor is positioned adjacent to the entrance gate. The cloud will record and store the characters of the license plate for use by the parking facility.

In order to address the inefficiency and errors associated with parking ticket processes and other current processes of entering, paying and exiting the parking facility, the system and method of the present invention removes the need for contract parkers to use access devices and a requirement for regular parking customers to carry around with them any type of document issued to them over the internet or at the entrance, such as a ticket. Parking customers have the option to use issued documents, such as validations or internet coupons.

For non-contract parkers, the system and method of the present invention allows for the customer to drive toward the entrance of the parking facility to a kiosk, pedestal, or other such set-up where the first control panel is installed. The parker will type or speak a predetermined number of characters (alphanumeric characters such as numbers and/or letters) into the first control panel. The parker will use this as an identifier when paying. The parker can use an identifier (primarily personal and unique) that can later be replicated at the second control panel in order to calculate the time in the facility and required payments. The identifiers include, but are not limited to, numbers such as phone numbers, birthdays, or a combination of personal numbers, words or strings of numbers or letters, touch, voice, eye scans, or other personal biometrics.

The cameras read and record each license plate entering the parking area. These license plates are then recorded and matched to the characters or unique identifiers used at the first control panel at the entry. The event time (i.e. the entry time) is been attributed to both the license plate and the personal identifier. The non-contract customers can now enter the facility without the need to carry a ticket with them after parking.

In order for customers to pay for their parking, they will simply need to replicate the information or identifier used at the entrance. An example of this would be typing or speaking the same number used to enter or using the same biometric touch signature pattern. The system then knows what time the parker entered the facility and can calculate the required payment. The customer can pay using a variety of options including, but not limited to, cash, credit cards, validations, internet discount certificates, a cell phone, or by reservation. The phone number or other identifier that is matched with the license plate of the vehicle at the entrance such that, after payment, the system will know that a payment for a specific license plate has been made.

Near the exit, the vehicle will drive by a device that captures the license plate and queries to the system to learn the payment status of this plate. If the parker has paid, the system will open or keep open the exit gate. If the parker has not paid, he or she will not be allowed to exit until payment is made at the exit station. For contract parkers, the phone number or identifier can be used in lieu of, or as an ancillary control to, access devices such as badges, cards, or automated vehicle identification. The system can be programmed for the entrance gate will open a remain open if the vehicle entering as a license plate registered to a contract parker. If contract parkers drive multiple vehicles, the system and method of the present invention allows them to register each of their vehicle's license plate numbers so that each one of the vehicles can gain access to a parking area. If the on-site devices has an issue reading the license plate of a contract parker, a customer can simply use their phone number or unique identifier to gain access to the parking facility.

As used herein, the term “customer number”, of course, refers to numbers, words, touch, voice, eye scans, or other personal biometrics. The “customer number” can also include recorded information relating to contract parkers. As such, this “customer number” can also include items such as badges, cards, or automated vehicle identification.

This foregoing section is intended to describe, with specificity, the preferred embodiments of the present invention. It is understood that modifications to these preferred embodiments can be made within the scope of the present claims. As such, this section should not be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a diagrammatic illustration of the system and method of the present invention as used at the entrance of a parking facility.

FIG. 2 is a diagrammatic illustration of the system and method of the present invention at the exit of the parking facility.

FIG. 3 is a frontal view of the first control panel of the system and method of the present invention as used at the entrance of the parking facility.

FIG. 4 is a frontal view showing the second control panel of the system and method of the present invention is used at the exit of the parking facility.

FIG. 5 is a plan view of the display associated with the second control panel for use in association with securing payment at the exit of the parking facility.

FIG. 6 is a flow diagram solid showing the integration of the system and method of the present invention and the processing of the system of data in association of the system and method of the present invention.

### DETAILED DESCRIPTION OF THE INVENTION

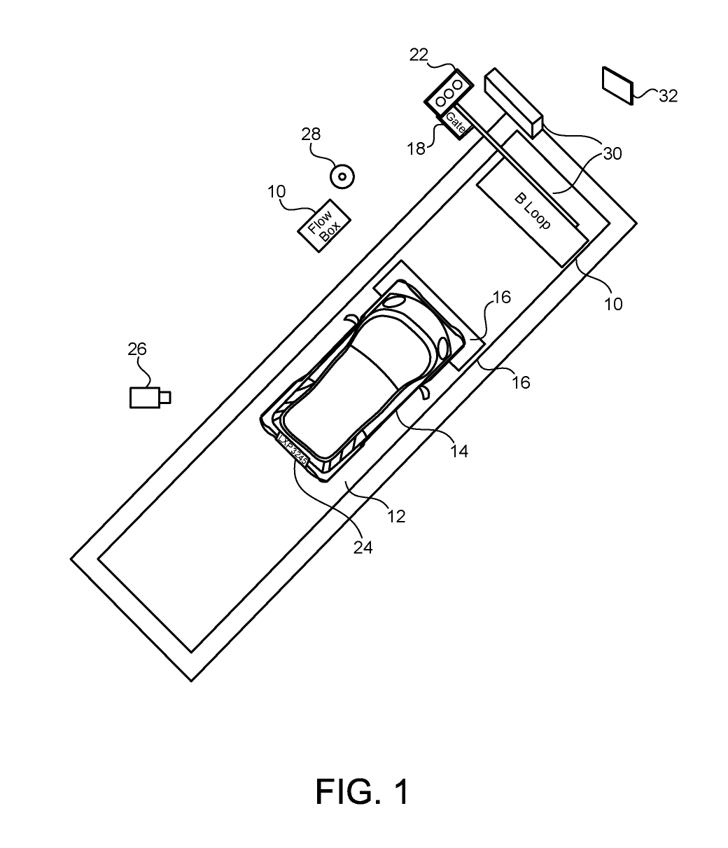

FIG. 1 illustrates the system and method of the present invention at the entrance of the parking facility. In particular, in FIG. 1, it can be seen that a first control panel 10 is located adjacent to an entrance pathway 12 of the parking facility. A vehicle 14 is illustrated on the entrance pathway. A proximity sensor 16 is located on the entrance pathway a distance from the entrance gate 18. Another proximity sensor 20 is positioned adjacent to the gate 18. When the vehicle 14 approaches the first proximity sensor 16, the system of the present invention will detect the presence of the vehicle adjacent to the first control panel 10. Ultimately, when the gate 18 is opened, and when the vehicle 14 moves in the direction of the gate 18, the second proximity sensor 20 will detect the presence of the vehicle so that the gate 18 does not inadvertently lower. After the vehicle has passed the second proximity sensor 20, the gate 18 will be lowered so as to prevent entrance of another vehicle.

The vehicle 14 has a license plate 24 thereon. A camera 26 is positioned adjacent to the entrance pathway 12 and directed generally in the direction of the gate 18. Camera 26 is specifically directed toward the license plate 24. The camera 26 will take a picture of the license plate 24 and record characters on the license plate 24. Another command center camera 28 is also positioned adjacent to the gate 18 so as to allow the operator of the parking facility to observe any actions that may occur in the area of the entrance pathway 12. A lighted sign 30 is provided beyond the entrance gate 18 so as to provide information to the operator of the vehicle 14 with respect to the current facility. An automated vehicle identification detector 32 is provided in a location forward of the gate 18 so as to allow automated identification of the vehicle 14.

As used herein, when the driver of the vehicle 14 approaches the first proximity sensor 16, the operator of the vehicle can then access the first control panel 10 so as to enter a customer number therein. As stated hereinbefore, this customer number can include numbers, words, touch, voice, eye scans, or other personal biometrics. The numbers can include phone numbers, birthdays, or a combination of personal numbers. The words can be a string of numbers or letters. Additionally, this customer number can also include the identification information received by the automated vehicle identification system 32. At the same time, the camera 26 will record the characters on the license plate 24. As will be described hereinafter, the system will correlate the license plate identified by the camera 26 with the customer number entered into the control panel 10. Once the customer number is entered into the control panel 10 and when the camera 26 has taken a picture of the characters of the license plate 24, the gate 18 will lift so as to allow the vehicle 14 to pass by the second proximity sensor 20 and to enter the parking facility. When this information is properly entered into the control panel 10, the traffic light 22 will display the green collar so that the vehicle operator will know that entrance is permitted.

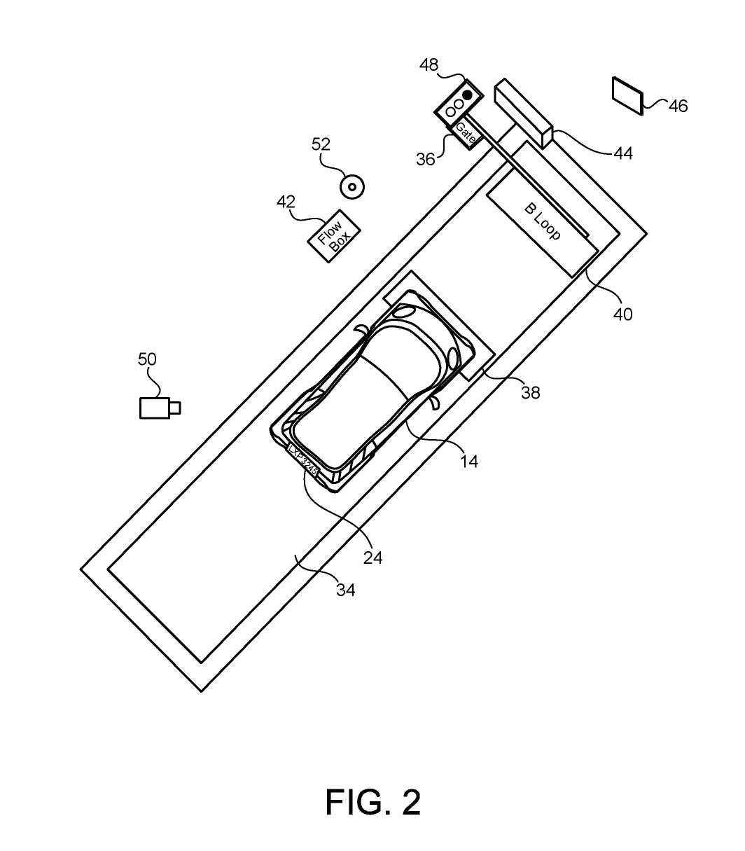

FIG. 2 illustrates the exit of the vehicle from the parking facility. As can be seen in FIG. 2, the vehicle 14 enters an exit pathway 34. Another gate 36 is positioned adjacent an end of the exit pathway 34. Proximity sensors 38 and 40 are positioned in spaced relationship to each other along the exit pathway 34. The first proximity sensor 38 will indicate when the vehicle 14 is adjacent to the second control panel 42. The second proximity sensor 40 will indicate when the vehicle approaches the gate 36 and when the vehicle 14 exits the parking facility. Another sign is located at the end of the exit pathway 34. Another automated vehicle identification device 46 is also located beyond the gate 36 and directed toward the vehicle 14 so as to remotely identify the vehicle. Another traffic light 48 is positioned adjacent to the gate 36. The traffic light 48 will have a configuration similar to that of the traffic light 22 as shown in FIG. 1.

In FIG. 2, it can be seen that the vehicle 14 has a identical license plate 24 to that of license plate 24 shown in FIG. 1. A second camera 50 is directed toward the license plate 24 so as to receive in the image information pertaining to the characters on the license plate 24. Another command center camera 52 is also directed toward the exit pathway 34 so as to allow the operator the parking facility to monitor action in the area of the exit pathway. As used herein, it is possible within the concept of the present invention that both the exit pathway 34 and the entrance pathway 12, along with the gates 18 and 36, are the same. Under certain circumstances, the system of the present invention can be used in those circumstances where the facility has only a single entrance and exit.

The second control panel 42 is placed in proximity to the vehicle 14 when the vehicle 14 encounters the first proximity sensor 38. The second control panel 142 could also be at a pay-on-foot station away from the exit. As such, the operator of the vehicle 14 can enter the same customer number into the second control panel 42 that was entered into the control panel 10 upon entrance. Additionally, the camera 50 will obtain image information pertaining to the license plate 24. If the customer number entered into the control panel 42 upon exit matches the customer number entered into the first control panel 10 upon entry, and if the characters of the license plate 24 match upon exit and entry, the system of the present invention will allow the gate 36 to open so that the vehicle 14 can exit the parking facility.

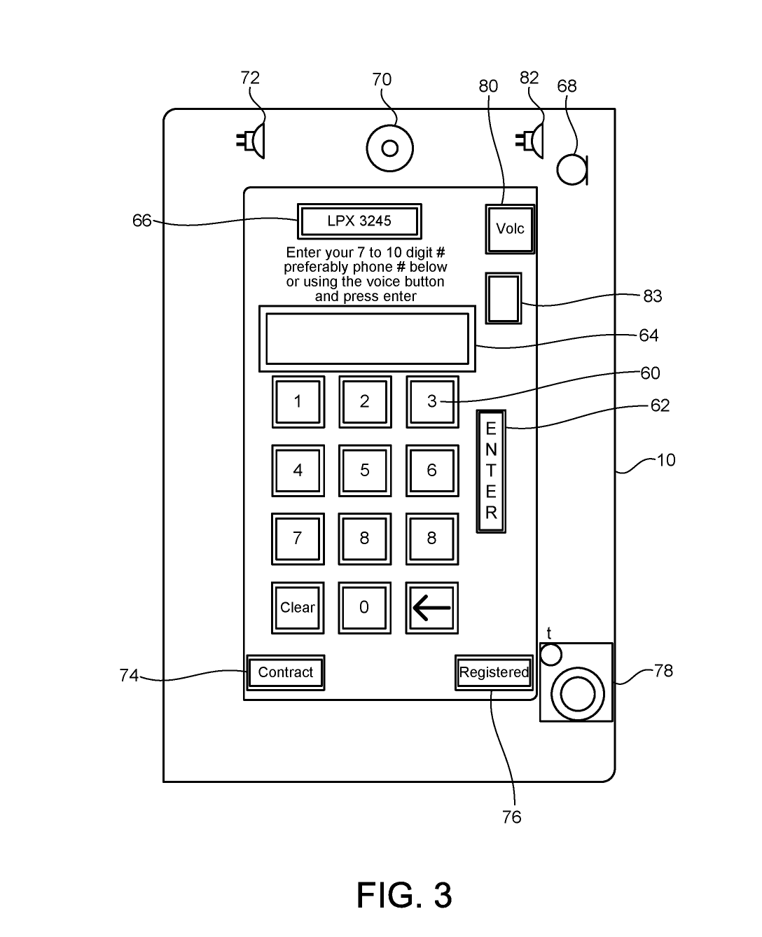

FIG. 3 is an illustration of the first control panel 10 at the entrance to the parking facility. The first control panel 10 includes an entry keypad 60 that includes a plurality of numerical keys arranged in the nature of a telephone keypad. However, within the concept of the present invention, the entrance keypad 60 can also be a keyboard. The numerical display of entry keypad 60 allows a 7 to 10 digit number to be entered. Within the concept of the present invention, at least five digits should be entered on to the entry keypad 60. This would be the customer number. As stated hereinbefore, the customer number can be personal to the user such that the user can remember the customer number upon exit. After the customer number has been entered on the entry keypad 60, the enter button 62 can be pressed. The number will to be displayed on display 64. Additionally, the characters identified by the camera on the license plate 24 identified by the camera 26 will be displayed on another display 66. As such, the user will be able to see if the license plate characters have been properly identified by the camera 26.

The first control panel 10 can also include a microphone 68 positioned so as to allow the user to have voice recognition for voice entry into the parking facility. A camera 70 can also be placed on the first control panel 10 so that the operators of the parking facility can view the driver of the vehicle. A speaker 72 is provided on the first control panel 10 so as to allow the operator of the facility to announce instructions to customers. A contact button 74 is provided. If the contact button 74 is depressed or actuated, the operator of the vehicle at the entrance of the parking facility can communicate with a central system such that the central system can provide instructions or other information relative to the parking facility. If the parker of the vehicle is a registered parker, then the “Registered” button 76 can be pushed or actuated so that the system of the present invention will recognize that the user is registered. As such, any parking fees can be tallied onto an account of the customer. An intercom 78 is provided on the control panel 10 so as to allow the operator of the vehicle to communicate with the facility, as required.

In certain circumstances, the “customer number” can actually be a voice identification. If the operator of the vehicle desires to enter the customer number will have his or her voice recognized, then the voice recognition button 80 should be depressed or actuated. A speaker 82 is provided on the control panel 10 so as to provide instructions to the user. There is a thumbprint identifier 83 provided on the face of the first control panel 10. With sophisticated technology, the customer number can actually be a thumbprint. As such, the thumbprint sensor 83 can be used by the operator of the vehicle instead of the alphanumeric code entered onto the display 64.

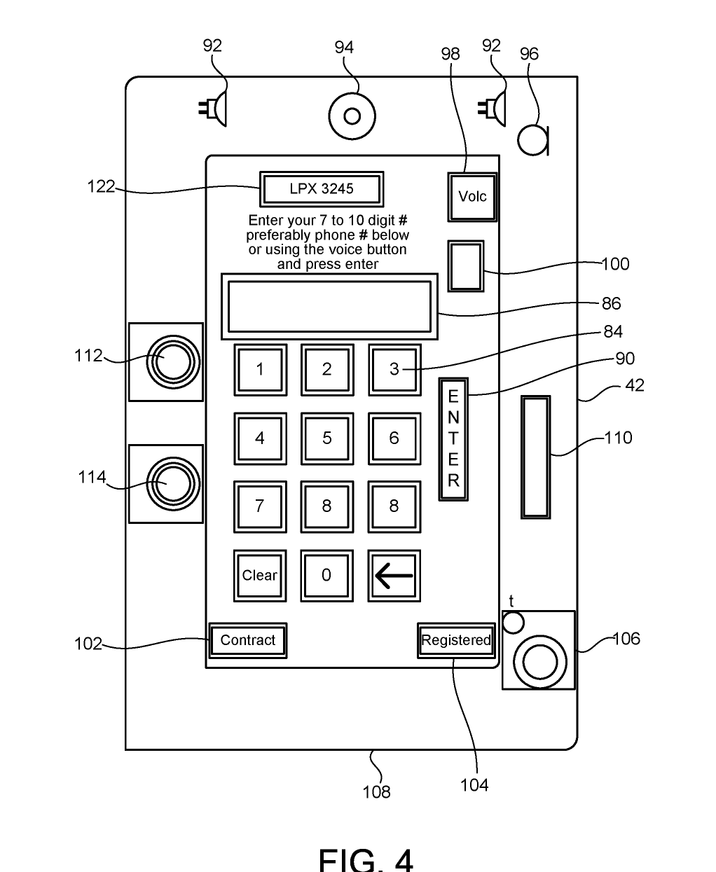

FIG. 4 illustrates the configuration of the second control panel 42 as used at the exit of the parking facility. The second control panel 42 includes a second keypad 84 on the face thereof. This second keypad 84 will have a configuration similar to the keypad 60 of the first control panel 10. In other words, the keypad 84 can be a numeric keypad (as is illustrated in FIG. 4) or could be an alphanumeric keyboard. Upon exit of the vehicle 14 from the parking facility, the user will enter on the second keypad 84 the same customer number that was entered on the first keypad 60 of the first control panel 10. This customer number will be displayed on display 86. Additionally, the characters of the license plate 24 obtained by the camera 50 will be displayed on display 88. The license plate characters shown in display 88 should match the license plate characters shown on display 66 of the first control panel. As such, if the customer number is identical to the customer number entered on the first control panel and if the license plate characters shown in display 88 are the same as the license plate characters shown on the display 66, then the system will allow for the exit of the vehicle.

After the customer number has been entered on the keypad 84, the enter button 90 can be depressed or actuated so that the system will recognize that the proper code is been entered. If any errors are made in the entry of the customer number, then conventional buttons on the keypad 84 can be utilized so as to correct for this error.

The second control panel 42 also include similar features as the first control panel 10. The second control panel 42 can include speakers 92, camera 94, a microphone 96, a voice identification button 98, and a thumbprint sensor 100. The control panel 42 can also include the contact button 102 and the registered user button 104. An intercom 106 is present provided generally adjacent to the bottom 108 of the control panel 42 so as to carry out communications with a facility.

The second control panel 42 can also operate so as to allow payment to be entered. As such, the second control panel 42 includes a credit card reader 110. This can be a slide-type credit card reader so that automatic payment can be made. Alternatively, a barcode scanner 112 and/or a contactless credit card reader 114 can be provided on the control panel 42.

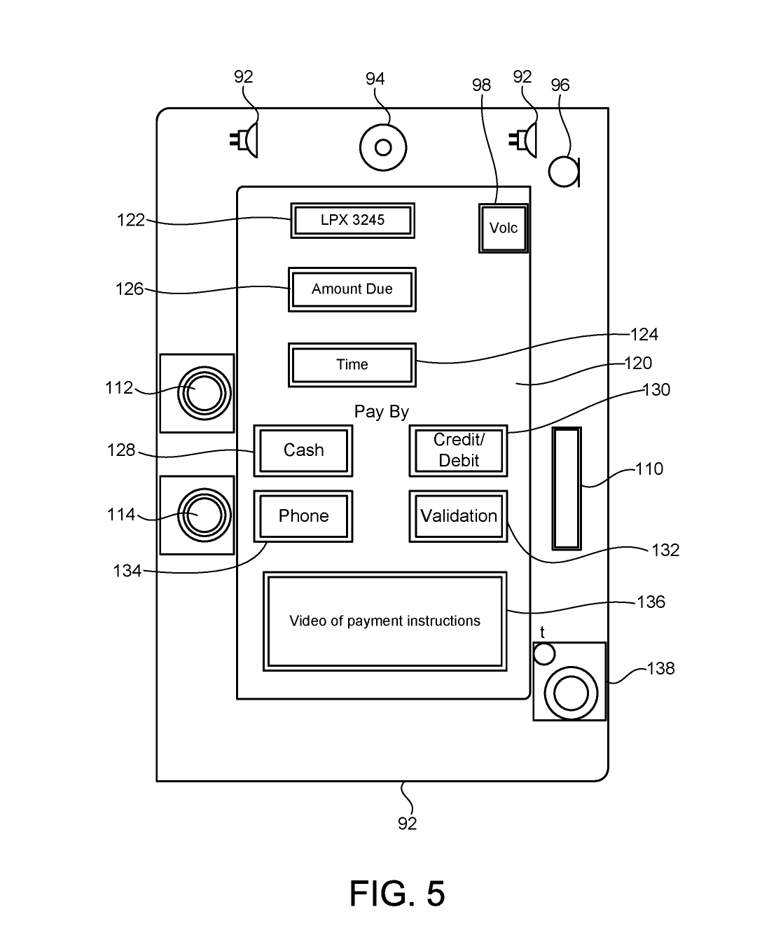

FIG. 5 shows a display associated with the second control panel 42. This display provides information to the user so as to facilitate the ability of the user to properly pay. The display can be a video display in the area occupied by the second keypad 84, and the displays 86 and 88. The display 120 includes an area 122 that shows the characters of the license plate. The system of the present invention will calculate the amount of time that the user has been in the parking facility and provide a display 124 of this time. The calculated amount of payment is shown in area 126 on display 120. Various payment buttons can also be included on the display 120. These payment options can include a cash button 128, a credit/debit card button 138 and a validation button 132. If necessary, the user can actuate the phone button 134 so as to verbally provide payment information. A section 136 on display 120 provides a video of payment instructions.

As with the control panel shown in FIG. 4, FIG. 5 shows that the second control panel 42 provides speakers 92, camera 94, voice recognition 96, credit card reader 110, a credit card slot 136, and intercom 138, the credit card slot 137, the barcode scanner 112 and the contactless credit card reader 114.

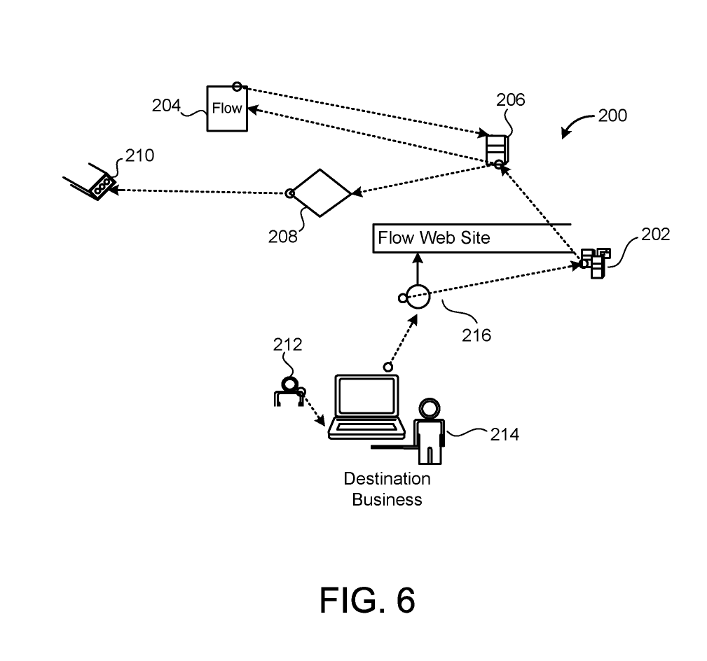

FIG. 6 shows a flow diagram associated with the processing of information in the system 200 of the present invention. A central server 202 is provided. The central server 202 can receive information from the control panels 204. Control panels 204 can include the first control panel 10 in the second control panel 42. A location server 206 is provided so as to pass information to the central server 202. A lane controller 208 is further connected to the system so as to provide an indication of which lane was utilized by the vehicle. The traffic light signals 210 can further be connected to the lane controller 56 and ultimately pass as information to the central server 202. The information pertaining to the customer 212 can be passed to a validation client 214. This registered user can interact with the central server so as to provide information that the user of the parking facility is registered. A webpage 216 can also be used so as to facilitate the parking. Each of these components interact with the central processor 202 so as to provide the system with information pertaining to parking duration, amount of payments received, the number and type of users, customer information, and various other results. Ultimately, the tabulation of this information by the central processor 202 can be delivered to a parking facility so that the parking facility will able to better assess its success or profitability or to assess problems associated with the parking facility.

In the present invention, the system will replace the traditional ticket dispensing machine. The present invention utilizes the control panels and the license plate recognition cameras. The traditional data mechanisms are used to block access until the parker either proves that they have credentials as a contract parker or that they have a ticket to compute the payment. The signs will provide go or stop messages to the driver. When the vehicle is adjacent to the proximity sensors, the control panel will activate and the camera will take a picture of the license plate of the entering vehicle when the vehicle passes over the proximity sensors.

When the customer in a vehicle arrives in a position adjacent to the control panel 10, the screen of the control panel will display the license plate of the vehicle and will verbally announce through the speakers, or other speakers and a video machine located adjacent to the control panel 10, a message to enter or to speak the customer number. This customer number can be entered utilizing the keypad 60 or the voice button 80 and the microphone 88. The enter button 62 can then be actuated. As the customer enters the customer number using the keypad 60 or the voice button 80, the number will display on the screen 64. When the customer enters the enter button 62, the number entered by the customer becomes the customer number that the customer will need to calculate their parking fee at the pay-on-foot station or the exit station. The number is then stored in the location server 206 so as to be recalled when the customer is ready to pay at a pay-on-foot station or at the exit control panel 42. Additionally, for the purpose of speeding the exit, the license plate number can be stored and paired to the number entered in the screen 64.

The customer no longer needs to carry a paper ticket because they have the number the entered at the first control panel 10. At a pay-on-foot station, the parking software stored on the server 206 needs to identify the customer so that it can check to see the date, time and location of entry in order to compute the amount due. In the preferred embodiment of the present invention, a customer will enter his or her phone number or other unique individual identifier that was presented in the first control panel 10 by using the keypad or the voice button and microphone to identify the time they entered the facility. Ultimately, the amount due can be displayed at the pay-on-foot station along with the total time parked. The user can then choose the various payment options of cash, credit/debit card or validation. The customer can then pay by their preferred method. Any balanced due will still be shown on the screen.

The system of the present invention links the payment using the phone number or unique customer number to the license plate or automated vehicle identification. When the customer arrives at the exit the parking facility, the camera 50 in the exit pathway 34 will take a picture of the customer's license plate and match it to the customer number. The software in the server will then know that the customer number linked to the license plate has been paid so that there is no need for the customer to stop before exiting the parking facility. In most parking facilities, there is a time limit as to the amount of time elapsed from the payment at the pay-on-foot station to the exit. This limit is called the exit grace period. When the vehicle arrives at the exit, the camera 50 will take the picture and send the information to the server 206. This will show a grace period violation. The information from the server will identify the license plate of the exiting vehicle as a link to the customer number that has been paid. As such, if the grace period has been exceeded, then the display will show that an additional amount is owed.

Those circumstances where the customer did not stop at a pay-on-foot station and simply arrived at the exit lane, the camera 50 will take a picture of the license plate and send it to the server 206. The server determines if this license plate belongs to a customer that entered the facility using their customer number. It will show that the charge has not been paid or that the vehicle is past the exit grace period. The exit gate will stay down and/or the exit light will stay red so that the vehicle will stop at the second control panel 42. The customer can enter their customer number using the keypad or the voice button and microphone into the second control panel 42. The customer number and license plate match will be checked at the server 206 and the display will show the amount due and the time to park. The various other payment options will also be provided. Once the customer selects a payment option, the screen will show the amount paid, any balance that is due, and the payment options if there is any remaining balance. Once the total due is paid, the gate will rise or the traffic light will become green. The display of the control panel 42 can also change to a green color so that the customer will feel free to exit the parking facility.

At any time during the entry, pay-on-foot station, or at the exit transaction, the customer can always activate the intercom so to talk to an assistant who can help with the completion of the transaction.

A validation is a type transaction where the destination (validator) of the customer wishes to pay part or all of the customer's parking fee. Traditionally, the customer must have a paper parking ticket with them to be used by the validator to process the validation. In the present invention, the customers use their customer number to identify what parking facility they parked and the time of entry. When the destination of the parking customers is ready to validate the customer, the destination will give the destination employee their customer number. The employee can then enter it into the control panels along with the amount in terms of time or currency of the validation. The system communicates with the central server 202 which, in turn, communicates with location server 206. When the customer arrives either at the pay-on-foot station or at the second control panel 42 and enters the customer number, the pay-on-foot station or the control panel 42 communicates with the server 206 and finds a validation amount tagged to this particular customer number. The server uses the amount of the validation to calculate the parking charge and communicates with either the pay-on-foot station or the control panel.

An important feature of the present invention is that the visiting customer voice carries with them the ability to be recognized at the parking facility employing the present invention. This is because the customer always have their particular customer number with them. Upon entry to a facility for the first time, the customer number is matched to the license plate of the vehicle. If the customer chooses to be registered in the software associated with the system of the present invention and add a credit card to the account, they can enter and exit either by using the license plate number or customer number without having to stop for payment.

Contract parkers can enter the facility either using their contract access card, automated vehicle identification card, or they can have the license plate number for each of the vehicles registered. Any one of these three access methods can be used for access and exit of the parking facility. In the preferred embodiment of the present invention, the customer number will be a back-up when or if the chosen contract parker access method fails. For a contract parker whose preferred method of contract access fails for any reason, the contract parker can simply go through the control panels and enter the customer number so as to gain access to the facility. The customer would then need to contact management correct any error in their preferred method of access before they will be allowed to exit the garage.

The foregoing disclosure and description of the invention is illustrative and explanatory thereof. Various changes in the details of the illustrated construction or in the steps of the described method can be made within the scope of the present claims without departing from the true spirit of the invention. The present invention should only be limited by the following claims and their legal equivalents.

I claim:

1. A method of tracking vehicles at a parking facility, the method comprising:
providing a first control panel and a camera adjacent an entrance of the parking facility;
entering a customer number into the first control panel;
recognizing characters on a license plate by the camera at said entrance;
allowing the vehicle to enter the parking facility;
entering the customer number upon exit from the parking facility; and
allowing exit from the parking facility of the customer number matches the customer number entered at the entrance.

2. The method of claim 1, further comprising:
correlating said characters of said license plate with the customer number.

3. The method of claim 2, the step of allowing the vehicle the exit comprising:
allowing exit from the parking facility if the customer number and the characters of said license plate at the entrance match the characters of the license plate and the customer number at the exit.

4. The method of claim 1, further comprising:
providing a second control panel associated with the exit of said parking facility, the step of entering the customer number upon the exit being at said second control panel.

5. The method of claim 4, further comprising:
entering payment information in said second control panel, the step of allowing exit comprising allowing exit upon an entry of payment information into said second control panel.

6. The method of claim 1, further comprising:
detecting a presence of said vehicle at the entrance of said parking facility.

7. The method of claim 1, further comprising:
transmitting said customer number and the characters of said license plate to a remote location.

8. The method of claim 1, said entrance having a gate thereat, the step of allowing entrance comprising:
lifting said gate when said camera recognizes said characters of said license plate and when said customer number is entered.

9. The method of claim 1, further comprising:
calculating a payment amount based upon an amount of time passing between the step of allowing the entrance and when said vehicle approaches the exit.

10. The method of claim 9, the step of calculating the payment comprising:
calculating the payment based upon an amount of time passing between the step of allowing the entrance and when said customer number is entered upon exit.

11. The method of claim 1, said customer number being an alphanumeric code of at least five digits.

12. A parking system comprising:
an entrance gate;
a first control panel positioned adjacent said entrance gate, said first control panel having a first keypad adapted to allow entry of a customer number;
a first camera directed toward an area adjacent said entrance gate, said first camera directed so as to recognize characters of the license plate of a vehicle positioned adjacent said entrance gate;
an exit gate;
a second control panel associated with said exit gate, said second control panel having a second keypad adapted to allow entry of the customer number thereon; and
a processor connected to said first control panel and said second control panel, said processor for allowing said exit gate to open if said customer number of said first control panel matches said customer number of said second control panel.

13. The parking system of claim 12, said processor connected to said first control panel and said first camera so as to correlate the customer number with the characters of the license plate.

14. The parking system of claim 13, said processor connected to said second control panel and to said second camera so as to recognize that the customer number and the characters of the license plate at the entrance gate match the customer number and the characters of the license plate at said exit gate.

15. The parking system of claim 12, said entrance gate and said exit gate being a common gate.

16. The parking system of claim 12, said processor being cloud-based, said processor calculating an amount of time passing between an opening of said entrance gate and the entry of the customer number at said exit gate.

17. The parking system of claim 16, said second control panel having a payment entry thereon, said second control panel having a display thereon, said processor calculating an amount of payment based upon the amount of time such that the amount of payment is displayed on said display.

18. The parking system of claim 12, further comprising:
a proximity sensor positioned adjacent said entrance gate.

19. The parking system of claim 12, said processor recording and storing the characters of the license plate.

20. A method of tracking vehicles in a parking facility, the method comprising:
providing a first control panel and a camera adjacent an entrance of the parking facility;
entering a customer number into the first control panel;
recognizing characters on a license plate by the camera at the entrance;
allowing the vehicle to enter the parking facility;
entering the customer number upon exit from the parking facility;
recognizing the characters of the license plate of the vehicle at the exit; and
allowing exit from the parking facility of the customer number and the characters of the license plate of the vehicle at the entry match the customer number and the characters of the license plate at the exit.
